(19) United States
(12) Patent Application Publication
(10) Pub. No.: US 2006/0086072 A1
(43) Pub. Date: Apr. 27, 2006

(54) Filter structure for a nailer

(75) Inventors: Roman Ho, Taichung (TW); Laing-Chi Hung, Taichung (TW)

Correspondence Address: CHARLES E. BAXLEY, ESQ., 90 JOHN STREET, THIRD FLOOR, NEW YORK, NY, 10038, US

(73) Assignee: Basso Industry Corp.

(21) Appl. No.: 10/970,082

(22) Filed: Oct. 21, 2004

(51) Int. Cl. B01D 50/00

(52) U.S. Cl. 55/385.1

(57) ABSTRACT

The present invention relates to a filter structure for a nailer, wherein a step periphery and a groove are formed on an inner wall of a nailer, a filter plate is disposed in the step periphery, and then a fastener is received in the groove for limiting the filter in the step periphery of the nailer. Thus the filter plate will not fall off when the user assembles and disassembles other components of the nailer. In addition, the filter structure is able to prevent the filter plate from being deformed when the user assembles and disassembles other components of the nailer.

### BACKGROUND OF THE INVENTION

1. Field of the Invention

The present invention relates to a nailer, and more particularly to a filter structure for a nailer which is capable of positioning the filter plate and preventing the filter plate from being deformed when reassembling and assembling other components of the nailer.

2. Description of the Prior Arts

Most of the nailers are provided with a filter which is directly fixed between the main body of a nailer and a rear plug. The filter will fall off whenever the rear plug is removed from or assembled to the main body of the nailer, thus, not only this filter structure makes the filter difficult to be assembled on the nailer, but also the filter is likely to be moisturized and dirtied. Furthermore, when the user screws the rear plug into the main body of the nailer, the rotation of the rear plug will cause deformation of the filter, so that the filtering function of the filter is weakened.

The present invention has arisen to mitigate and/or obviate the afore-described disadvantages.

### SUMMARY OF THE INVENTION

The primary objective of the present invention is to provide a filter structure for a nailer, wherein a step periphery and a groove are formed on an inner wall of a nailer, a filter plate is disposed in the step periphery, and then a fastener is received in the groove for limiting the filter in the step periphery of the nailer. Thus the filter plate will not fall off when the user assembles and disassembles other components of the nailer.

The second objective of the present invention is to provide a filter structure for a nailer capable of preventing the filter plate from being deformed when the user assembles and disassembles other components of the nailer.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a filter structure for a nailer in accordance with the present invention;

FIG. 2 is an assembly cross sectional view of the filter structure for a nailer in accordance with the present invention;

FIG. 3 is a cross sectional view of a filter structure for a nailer in accordance with a second embodiment of the present invention;

FIG. 4 is a cross sectional view of a filter structure for a nailer in accordance with a third embodiment of the present invention.

### DETAILED DESCRIPTION OF THE PREFERRED EMBODIMENTS

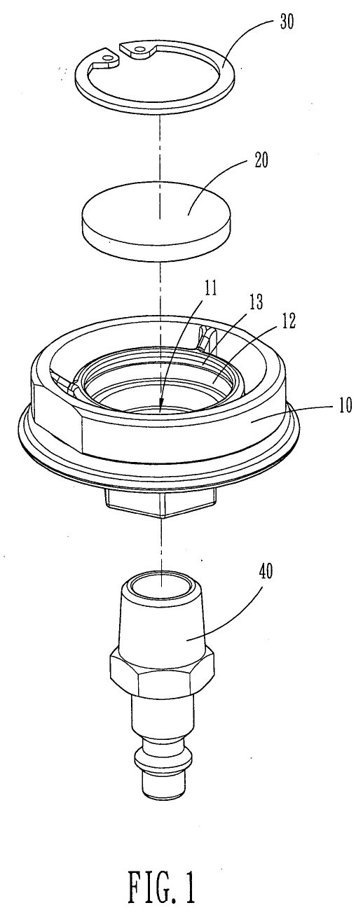

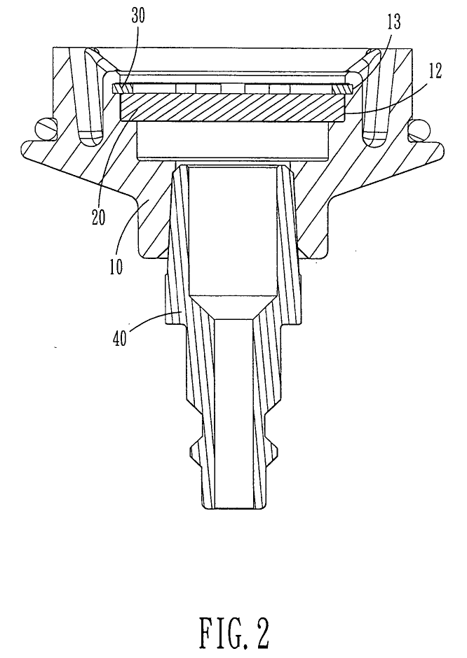

Referring to FIGS. 1 and 2, a filter structure for a nailer in accordance with a present invention comprises: a rear plug 10, a filter plate 20, a fastener 30 and a quick release connector 40.

A rear plug 10 is formed with a through hole 11, on the inner wall of the through hole 11 are provided a step periphery 12 and a groove 13. The groove 13 is formed at a side of the step periphery 12 and located in the direction of the nailer.

The filter plate 20 is formed in response to the shape of the step periphery 12 of the rear plug 10 so as to be received therein.

The fastener 30 is retained in the groove 13 of the rear plug 10 so as to limit the filter plate 20 in step periphery 12.

The quick release connector 40 is inserted in the through hole 11 of the rear plug 10.

When the user removes the rear plug 10 from the nailer, the filter plate 20 will be retained firmly in the rear plug 10 by the fastener 30. Furthermore, the groove 13 and the step periphery 12 also can be formed on the inner wall of the gun-barrel and the inlet-channel of the nailer for retaining the filter plate 20.

It is to be noted that since the fastener 30 fixes the filter plate 20 in the step periphery 12, the deformation of the filter plate 20 can be prevented when the rear plug 10 is screwed to the nailer.

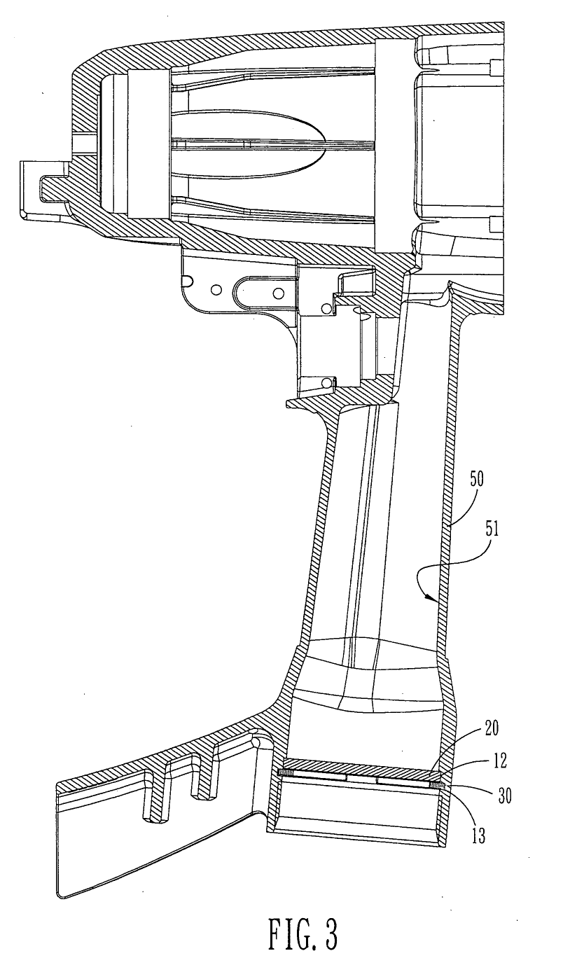

Referring to FIG. 3, which shows a filter structure for a nailer in accordance with a second embodiment of the present invention, wherein the step periphery 12 and the groove 13 can be formed directly on the inner wall of the inlet channel 51 of the nailer 50, while the groove 13 is located in an opposite direction to the nailer 50. Since the fastener 30 also serves to limit the filter plate 20 in the step periphery 12, the filter plate 20 can be retained firmly in the rear plug 10.

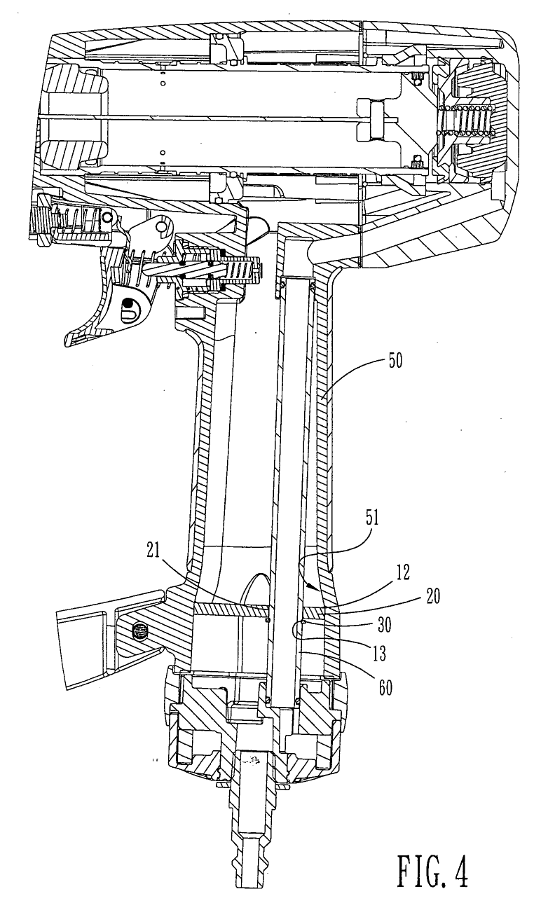

Referring to FIG. 4, which shows a filter structure for a nailer in accordance with a third embodiment of the present invention, wherein the step periphery 12 and the groove 13 are formed directly on the inner wall of the inlet channel 51 of the nailer 50 while the groove 13 is formed on the outer periphery of an outlet tube 60 which is disposed in the inlet channel 51. The filter 20 is provided with a through hole 21 for insertion of the outlet tube 60, and the groove 13 is located in the direction of the main body of the nailer 50. The fastener 30 serves to limit the filter plate 20 in the step periphery 12 by cooperating with the outlet tube 60. Thereby, the filter plate 20 can be retained firmly in the rear plug 10.

While we have shown and described various embodiments in accordance with the present invention, it should be clear to those skilled in the art that further embodiments may be made without departing from the scope of the present invention.

What is claimed is:

1. A filter structure for a nailer comprising: a step periphery and a groove formed on an inner wall of a nailer, a filter plate disposed in the step periphery, and a fastener received in the groove for limiting the filter in the step periphery of the nailer.

2. The filter structure for a nailer as claimed in claim 1, wherein the step periphery and the groove are formed on inner wall of a rear plug of the nailer, and the groove is located in the direction of the main body of the nailer.

3. The filter structure for a nailer as claimed in claim 1, wherein the step periphery and the groove are formed on inner wall of a gun-barrel of the nailer.

4. The filter structure for a nailer as claimed in claim 1, wherein the step periphery and the groove are formed on inner wall of an inlet channel of the nailer, and the groove is located in an opposite direction to the main body of the nailer.

5. The filter structure for a nailer as claimed in claim 1, wherein an outlet tube is provided in the inlet channel of the nailer, the step periphery is formed on inner wall of the inlet channel, and the groove is formed on an outer periphery of the outlet tube, the filter plate is provided with a through hole for insertion of the outlet tube, and the groove is located in an opposite direction to the main body of the nailer.
